(19) United States
(12) Patent Application Publication
(10) Pub. No.: US 2003/0229154 A1
(43) Pub. Date: Dec. 11, 2003

(54) Frothed energy absorbing polyurethane materials and process of manufacture

(76) Inventors: William Bruce Kemmler, Mooresville, NC (US); John Bruce Appleby, Perkomenville, PA (US)

Correspondence Address: Sanford J. Piltch, Esq., Suite 201, 1132 Hamilton Street, Allentown, PA, 18101, US

(21) Appl. No.: 10/164,810

(22) Filed: Jun. 7, 2002

(51) Int. Cl. C08J 9/00; C08G 18/00

(52) U.S. Cl. 521/155

(57) ABSTRACT

The present invention is directed towards a method of manufacturing frothed polyurethanes from raw materials that may best be described as quasi-prepolymer types where a partial prepolymer is reacted with a polyol. A partial pre-polymer, such as 4-4′-diphenylmethane diisocyanate, may be combined with a 4000 MW propylene-oxide based polyether polyol, such as polypropylene glycol which may be end-capped with a polyethylene glycol, or a 6000 MW propylene-oxide based polyether polyol, such as polypropylene glycol which may be end-capped with a polyethylene glycol, and a catalyst to produce frothed polyurethane material in sheet form having enhanced compressibility and elastic recovery.

### FIELD OF THE INVENTION

This invention relates to a method of forming a polyurethane elastomeric form having enhanced energy absorbing characteristics and the method of manufacturing the polyurethane elastomeric material.

### BACKGROUND OF THE INVENTION

Polyurethanes are the most well known polymers used in making foams. One such example is the padding in a chair where the cushion is more than likely made of a polyurethane foam. Polyurethanes are named because each such chemical compound contains a urethane chain or linkage. A simple urethane linkage is comprised of a central carbon atom attached on one side to two oxygen atoms, with one of the oxygen atoms attached to a complex aliphatic diol chain or group. On the other side the carbon atom is attached to a nitrogen atom that is attached to hydrogen atom and another complex aryl group. The number of simple linkages and composition of the groups create urethanes having differing compositions and properties, e.g. elastomers, coatings, adhesives, and fibers such as spandex. Polyurethanes are typically comprised of a diisocyanate and a diol. An example of such a combination is 4,4′-diisocyanatodiphenylmethane and a dialcohol, ethylene glycol.

Polyurethane elastomers have been produced commercially using one of three general processes: one-shot (all components are combined at one time), quasi-prepolymer (a partial prepolymer is reacted with a polyol), and prepolymer (a complete prepolymer is formed and then cured). These three processes may be described as follows and compared in terms of raw material cost, processability and overall elastomeric properties.

In the one-shot process, a polyisocyanate having an isocyanate content in excess of 28 wt. percent, which may be typically carbodiimide-modified MDI (4,4′-diphenylmethane diisocyanate) is reacted with a blend of polyol and curative. The advantages of this one-shot process are lowest raw material cost and ease of processability with stream ratios of 1:1 to 1:4. The principle disadvantage of this process is that urethanes prepared by the one-shot process typically have lower overall elastomeric properties, i.e. less energy absorption.

In the quasi-prepolymer process, a prepolymer having an isocyanate content of about 15 to 25 wt. percent is reacted with a blend of polyol and curative. Commercially available quasi-prepolymers are prepared by reacting MDI with a polyol. The quasi-prepolymer may contain some carbodiimide-modified MDI, 2,4′-MDI or a short chain diol (typically di- or tri-propylene glycol) to improve its liquidity at ambient storage temperatures. The advantages of the quasi-prepolymer process are processing ease with stream ratios of 1:1 to 1:3 and better overall elastomeric properties. The principle disadvantage is the higher raw material costs.

In the prepolymer process, typically all of the polyol is pre-reacted with a polyisocyanate (4,4′-MDI, toluene-diisocyanate (TDI), isopropyl-diisocyanate (IPDI), H₁₂MDI, etc.) to form a prepolymer. The prepolymer is then reacted with curative to form the urethane elastomer. The prepolymer process produces the best overall elastomeric properties, however, the disadvantages are higher raw material costs and more difficult processability stream ratios of 8:1 to 16:1.

In these three processes the polyurethanes are typically made from two monomers, a diol and an isocyanate. These two compounds react together with the help of a reaction enhancer or catalyst to make the two compounds polymerize. The catalyst may typically be diazobicyclo[2,2,2]octane [DABCO], which is stirred into the mixture of the diol and diisocyante. The introduction of the catalyst, DABCO, creates a chain reaction resulting in the polymerization of the two monomers so that a polymer (urethane dimer) with an alcohol group on one end and an isocyanate group on the other end results. The resulting dimer can react with another dimer, or a trimer, or even higher oligomers to form high molecular weight polyurethane. It is also possible to use a higher molecular weight polyethylene glycol (molecular wt approx. 2000) as the diol to achieve the high molecular weight polyurethane.

All of the processes described above to consistently make frothed polyurethanes are accomplished using high-pressure closed systems with the molecular weight of the formed polyurethane typically being in the 2000 to 3000 range. The present invention is distinguishable from these forms of polyurethane notably by its higher molecular weight, typically 4000 to 6000, for a more rigid material, its compressibility or impact resistance, i.e. energy absorption, and its elastic memory for returning the material to its pre-compressed form.

### SUMMARY OF THE INVENTION

The present invention is directed to a method of manufacturing frothed foam polyurethanes from raw materials which may best be described as quasi-prepolymer types where a partial prepolymer is reacted with a polyol. A partial pre-polymer, such as 4-4′-diphenylmethane diisocyanate, may be combined with a 4000 MW propylene-oxide based polyether polyol, such as polypropylene glycol which may be end-capped with a polyethylene glycol, or a 6000 MW propylene-oxide based polyether polyol, such as polypropylene glycol which may be end-capped with a polyethylene glycol, to form a frothed polyurethane material having enhanced compressibility and elastic recovery.

In addition, a catalyst, a chain extender, a curative, a surfactant, and/or a plasticizer may be added to the combination to produce the desired end material properties within a preferred time, at a preferred rate, and at a preferred temperature and pressure. The catalyst may be an amine or a metal catalyst, typically tin [Sn] based. The chain extender is often another polyol and the plasticizer, if needed, might typically be dipropylene glycol dibenzoate. A surfactant may also be utilized, but the surfactant may not contain any silicone [Si], as typically may be utilized with polyurethanes, as such will radically alter the desired properties of the frothed polyurethane material.

More particularly, the present invention is a frothed polyurethane composition consisting essentially of 35% to 65% by volume of a partial pre-polymer and 65% to 35% by volume of a propylene-oxide based polyether polyol in complimentary proportional percentage amounts exhibiting greater resiliency, energy absorption and force dissipation with materials of similar thicknesses, and of a substantially lighter weight and greater dimensional return elasticity. The partial pre-polymer may be selected from the group consisting of 4-4′-diphenylmethane diisocyanate (MDI), toluene-diisocyanate (TDI), and isopropyl-diisocyanate (IPDI), H₁₂MDI. The propylene-oxide based polyether polyol is selected from the group consisting of polypropylene glycol and polyethylene glycol.

The resulting frothed polyurethane composition has a substantially reduced weight of at least a 25% reduction as compared to similar compositions, with the substantially reduced weight resulting in a reduction of up to 65% in bulk density of the composition while retaining a resiliency reflected in a compressibility of less than 2%.

The frothed polyurethane composition may also use a catalyst which may be selected from the group consisting of amine and metal catalysts. The composition may further contain a plasticizer which may be dipropylene glycol dibenzoate.

As the preferred embodiment of the present invention, a method for manufacturing or forming the frothed foam polyurethane sheet material exhibiting greater resiliency, energy absorption and force dissipation with materials of similar thicknesses, and of a substantially lighter weight and greater dimensional return elasticity comprising the steps of blending in a high pressure mix head complimentary proportional percentage amounts of 35% to 65% by volume of a partial pre-polymer and 65% to 35% by volume of a propylene-oxide based polyether polyol; directing high pressure relatively inert gas at controlled volumetric flow rates into the mix head with the complimentary proportional percentage amounts of the partial pre-polymer and propylene-oxide based polyether polyol; and dispersing the reactive mixture through a spray head creating a frothed polyurethane composition deposited onto a backing member or form at a predetermined thickness for curing, whereby the resulting composition has a molecular weight in the range between 4000 and 6000, a Shore Hardness in the range between 20A and 30A, and at least a 25% reduction in weight due to the frothing effect of the high pressure relatively inert gas.

The method may comprise the additional step of mixing a catalyst with the propylene-oxide based polyether polyol prior to blending the complimentary proportional percentage amounts in the mix head. The catalyst may be selected from the group consisting of amine and metal catalysts. As above the partial pre-polymer may be selected from the group consisting of 4-4′-diphenylmethane diisocyanate (MDI), toluene-diisocyanate (TDI), and isopropyl-diisocyanate (IPDI), H₁₂MDI and the propylene-oxide based polyether polyol may be selected from the group consisting of polypropylene glycol and polyethylene glycol. All of the foregoing will create a resulting frothed polyurethane composition having greater impact absorption, enhanced compressibility and elastic recovery.

### BRIEF DESCRIPTION OF THE DRAWINGS

For the purposes of illustrating the invention, there is shown in the drawings, forms which are presently preferred; it being understood, however, that the invention is not limited to the precise arrangements and instrumentalities shown.

FIG. 1 is a schematic view of one embodiment of the apparatus used in the process of making the article of manufacture of the present invention.

### DETAILED DESCRIPTION OF THE PREFERRED EMBODIMENT

The following detailed description is of the best presently contemplated modes of carrying out the invention. The description is not intended in a limiting sense, and is made solely for the purpose of illustrating the general principles of the invention. The various features and advantages of the present invention may be more readily understood with reference to the following detailed description taken in conjunction with the accompanying drawings.

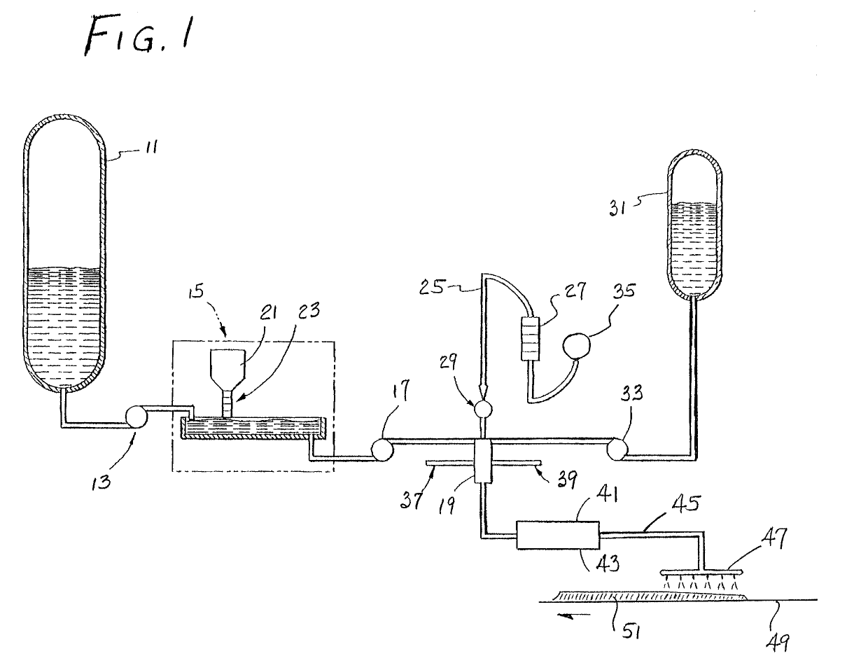

FIG. 1 shows the apparatus for creating the frothed polyurethane material of the present invention and may be considered as a process schematic. The method for making the polyurethane material in sheet form can be described as follows.

A holding tank 11 for the polyol, typically a propylene-oxide based polyether polyol, is provided which is connected by a variable speed metering pump 13 to blender 15. The blender 15 may be comprised of a typical solid/liquid blender having a supply hopper 21 containing a catalyst which is metered into the blender by means of an auger 23, or other suitable means. A high pressure pump 17 injects the mixture into a high pressure mix head 19 where mixing of the chemical components will be discussed more fully below.

A second holding tank 31, for containing the quasi-prepolymer, MDI, connects through a second high pressure pump 33 to the high pressure mix head 19. Compressed air, or some other relatively inert gas, is directed from compressor 35 to the high pressure mix head 19 through air injection line 25, with the rate of air injection determined by air flow meter 27 and the volume controlled by air flow valve 29.

From the high pressure mix head 19, the reactive mixture flows to a froth foaming mixing head 41, which may also include a secondary gas inlet 43 for adding additional frothing gas. The reactive mixture is dispersed from the froth foaming mix head 41 through a suitable conduit 45 to a spray head 47. The spray head 47 spreads the frothed foam reactive mixture onto a receiving backing on the conveyor 49 such that a sheet of the frothed polyurethane foam is deposited for curing on the conveyor 49, or into another suitable backing material or container, for curing into the polyurethane sheet 51.

The high pressure mix head 19 also has inlets 37 and 39 which may be used to supply additional streams of polyurethane ingredients such as cross-linkers, surfactants, colorants, additional blowing agents, and the like. Preferably the process is to be performed without additional ingredients, but the inlets 37, 39 are provided to be able to enhance the stoichiometry and resulting properties of the polyurethane sheet material by applying additives at the mix head 19.

Typical molecular weights for frothed polyurethane compounds are in the 2000 to 3000 MW range, or lower. The resulting frothed polyurethane of the present invention is in the range of 4000 to 6000 MW in order to achieve the resulting property of greater hardness, or greater rigidity. Typically, the higher molecular weight results in a Shore Hardness over the range of 20A-30A. This results in a greater compressibility, i.e. a more firm density of material, which is coupled with a controlled gas injection during mixing to provide a lesser overall weight, but without losing the hardness (firmness) or the compressibility.

The present invention is lighter in weight than prior materials with similar dimensional measurements having like usages. Weight is one important factor in energy absorbing pads for footwear or for the use of a gravitational force support in seating. One measure of the average weight per volumetric unit is bulk density. Bulk density testing will provide a uniform weight measurement for all samples of existing materials, as well as the new materials of the present invention. Testing was performed utilizing the ASTM 3574-95 Test Procedure within the temperature range of −30° F. to 210° F. on the samples in TABLE 1 below.

TABLE I

| BULK DENSITY | LBS/FT³ |
|---|---|
| Sorbothane | 80.00 |
| Bayflex | 70.50 |
| VDP 1*-medium | 65.44 |
| VDP 2-firm | 66.10 |
| 6000 MW-medium | 49.69 |
| 4000 MW-medium | 24.88 |
| 4000 MW-firm | 27.04 |

*VDP: visco-elastic dense polymer

The test results clearly indicate that the materials of the present invention, i.e. the 4000 MW and 6000 MW samples, display a significantly reduced weight per unit volume over the range 30% to 65% for similar materials currently available in the field.

However, this is only one important factor in producing an energy absorbing material. Another important factor is compressibility, i.e., the percent of return to the original dimension after deflection, or removal of a compression force. A Compression Test was performed on materials formed in accordance with the present invention as well as prior materials utilizing the ASTM D3574-95 Test Procedure for 50% deflection, i.e. the force necessary to compress the test material to 50% of original thickness. The test results are reproduced in TABLE 2 below.

TABLE 2

| COMPRESSION SET | % RETURN |
|---|---|
| VDP 1-medium | 2.34 |
| VDP 2-firm | 0.00 |
| 4000 MW-medium | 0.92 |
| 4000 MW-firm | 1.39 |

The testing shows that all of the materials will return to a difference of less than 2.5% of their original thickness. However, the materials of the present invention exhibited a more uniform return percentage for materials that are significantly of lighter weight. Thus the present invention exhibits an overall reduction in bulk density (weight) by up to 65% while retaining the ability to respond to the compression force and almost totally is return to the original thickness. This clearly exhibits an enhanced compressibility property, or “bounce-back”, which is to be understood as providing a greater resiliency to compression while retaining material elasticity to return to original dimensions.

An expanded testing of the sample materials of the present invention was performed, this time increasing the number of samples for comparison. In this test, the materials of the present invention were compared with commercially available samples, as well as samples of specific material compositions to determine maximum retained displacement from the original thickness dimension of the sample. The testing was accomplished using an ASTM-type A impact machine having an impact mass, a load cell, an accelerometer and an LVDT. The tests were performed by dropping an 8.5 kg mass from a height of 50 mm above the sample. Each of the samples was clamped to the table before impact with a rubber block 26.7 mm thick having a hardness of 65A placed between the table and each sample. The tabulated averages for the 30× repeated testing for each sample appear below.

TABLE 3

| COMPRESSIBILITY | MAX DISPLACE [MM] |
|---|---|
| Polyester Foam-soft [1″] | 24.13 |
| Polyester Foam-firm [¾″] | 19.44 |
| Polyethylene [⅜″] | 12.21 |
| Polyurethane [⅜″] | 11.68 |
| Confor Visco Foam-soft [⅜″] | 11.12 |
| Confor Visco Foam-med [⅜″] | 10.97 |
| 6000 MW-med [⅜″] | 10.96 |
| Confor Visco Foam-firm [⅜″] | 9.17 |
| 4000 MW-med [⅜″] | 8.87 |
| 6000 MW-med [¼″] | 7.99 |
| 4000 MW-med [¼″] | 7.84 |
| Polyethylene [¼″] | 7.80 |
| Polyurethane [⅜″] | 7.63 |
| 4000 MW-firm [⅜″] | 7.19 |

The results of this testing, again, clearly shows that the materials of the present invention, i.e. the 4000 MW and 6000 MW materials, provided less displacement distance from a neutral position. This can be restated by saying that the materials absorbed a greater amount of energy (force) with less displacement or physical compression of the dimensional thickness. Hence, the materials of the present invention possess a compressibility property that results in a lesser displacement from original thickness providing for greater energy absorption or force dissipation.

Testing of the sample materials of the present invention was also performed to determine the maximum force absorbed by the materials. The same testing as described above with regard to TABLE 3 was performed with the measurement being made to tabulate the maximum force absorbed by each sample of material. The results may be found in TABLE 4 below.

TABLE 4

| ENERGY ABSORPTION | MAX FORCE [N] |
|---|---|
| Confor Visco Foam-firm [⅜″] | 2590.04 |
| Polyester Foam-soft [1″] | 2534.41 |
| Confor Visco Foam-soft [⅜″] | 2478.02 |
| Polyester Foam-firm [¾″] | 2383.11 |
| Polyethylene [¼″] | 2057.02 |
| 4000 MW-med [¼″] | 1987.46 |
| Polyurethane [¼″] | 1840.31 |
| Polyethylene [⅜″] | 1791.42 |
| 6000 MW-med [¼″] | 1729.98 |
| 4000 MW-med [⅜″] | 1588.64 |
| 4000 MW-firm [⅜″] | 1463.47 |
| Polyurethane [⅜″] | 1371.47 |
| 6000 MW-med [⅜″] | 1334.36 |

The results tabulated reveal that the materials of the present invention produce a greater energy absorption than other samples, as the greater the maximum force number, in Newtons, the less impact absorption the material exhibits. Since the maximum force determined for each of the samples of the present invention, e.g., 4000 MW and 6000 MW samples, is in the lower half of the tested range, these materials clearly exhibit greater impact absorption. That is to say, when combined with the test results of the compressibility testing, the materials of the present invention can absorb a greater amount of energy while being displaced a lesser amount such that the resiliency and energy dampening of the materials, for their density and thickness, is better than the other samples of existing products and specimens of materials having similar properties.

The preferred method for making the frothed polyurethane sheet of the present invention is to utilize the mixing apparatus described above with the following chemical constituents for achieving the final article with the preferred properties or characteristics. A quasi-prepolymer, such as 4,4′-diphenylmethane diisocyanate [4,4′-MDI], as the propylene-oxide based polyethylene polyol, is mixed with the diol, which may be either polypropylene glycol [PPG] or polyethylene glycol [PEG] and a catalyst, such as diazobicyclo[2,2,]octane [DABCO] which assists in the reaction, or polymerization of the prepolymer and diol. The catalyst is preferred to comprise only 0.5 to 1.0 wt. percent of the mixture. The prepolymer, having a preferred molecular weight of 4000, and the diol are mixed in substantially equal quantities and aerated with compressed air (or other suitable gas mixture) in the range of 10-15 psig. The aeration pressure is dependent upon the viscosity of the mixture during reaction and the flow rate is determined by the size (volume) of the mix head and the amount of “bubbles” desired in the resulting foam polyurethane. Alternate gases which may be utilized are Nitrogen (N₂) and Nitrogen gas mixtures, such as air. The aerated “bubbles” or voids are intended to remain small and to be separated from each other in the foam polyurethane to reduce the overall weight and at the same time retain the compressibility of the resulting polyurethane material.

Alternatively, the prepolymer may have a molecular weight of 6000 and be mixed with a triol which may be either PPG or PEG. Further, the catalyst DABCO, which affects the rate of the chemical reaction of the prepolymer and the polyol, may be substituted by a tin [Sn] based catalyst, especially if the PEG polyol is being utilized. The catalyst component is added in the typical amount of 0.5 to 1.0 wt % to achieve a fairly short reaction time on the order of minutes.

Additionally, a plasticizer may be used to adjust the final properties of the resulting frothed polyurethane sheet by increasing the hardness. One plasticizer that is known to produce the desired results is Benzoflex (dipropylene glycol dibenzoate), which can be added to the mix up to a content of 10 wt. percent. The plasticizer will increase the flexibility of the resulting material, i.e. soften the material by making it more flexible. A plasticizer is not presently required for the process or the ultimate article, the polyurethane material 51. The 4000 MW MDI produces a frothed polyurethane sheet of moderate firmness of approximately 20A Shore hardness and the 6000 MW MDI produces a stiffer or more rigid result of approximately 30A Shore hardness.

The process produces a liquid compound at standard psi at ambient temperature through the spray nozzle 47 which does not normally require any additional curative as the compound sets up in less than one (1) minute. The liquid polyurethane compound is sprayed uniformly onto the backing material on the conveyor 49 across a pre-determined width, e.g., a six (6) foot width, so as to produce a sheet of the frothed polyurethane material 51. The material 51 is formed in standard thicknesses of 0.25 and 0.375 inches so that rolling or cutting for storage and/or transport can be easily accomplished.

The resulting polyurethane material 51 may be used for almost any energy absorbing function such as in footwear cushioning pads for the sole, in-step or heel, seating for home, office, and vehicle use, and energy dampening pads for controlling machine vibration. The polyurethane material exhibits the combined properties of greater resiliency, energy absorption and force dissipation with materials of similar thicknesses to the materials of the present invention, but with a substantially lighter weight and greater dimensional return elasticity.

The present invention may be embodied in other specific terms without departing from the spirit of essential attributes thereof and, accordingly, the described embodiments are to be considered in all respects as being illustrative and not restrictive, with the scope of the invention being indicated by the appended claims, rather than the foregoing detailed description, as indicating the scope of the invention as well as all modifications which may fall within a range of equivalency which are also intended to be embraced therein.

1. A frothed polyurethane composition consisting essentially of 35% to 65% by volume of a partial pre-polymer and 65% to 35% by volume of a propylene-oxide based polyether polyol in complimentary proportional percentage amounts exhibiting greater resiliency, energy absorption and force dissipation with materials of similar thicknesses, and of a substantially lighter weight and greater dimensional return elasticity.

2. The frothed polyurethane composition of claim 1, wherein the partial pre-polymer is selected from the group consisting of 4-4′-diphenylmethane diisocyanate (MDI), toluene-diisocyanate (TDI), and isopropyl-diisocyanate (IPDI), H₁₂MDI.

3. The frothed polyurethane composition of claim 1, wherein the propylene-oxide based polyether polyol is selected from the group consisting of polypropylene glycol and polyethylene glycol.

4. The frothed polyurethane composition of claim 1, wherein the substantially reduced weight of the composition is at least a 25% reduction.

5. The frothed polyurethane composition of claim 1, wherein the substantially reduced weight results in a reduction of up to 65% in bulk density of the composition while retaining a resiliency reflected in a compressibility of less than 2%.

6. The frothed polyurethane composition of claim 1, wherein the composition further consists of a catalyst.

7. The frothed polyurethane composition of claim 6, wherein the catalyst is selected from the group consisting of amine and metal catalysts.

8. The frothed polyurethane composition of claim 1, wherein the composition further consists of a plasticizer.

9. The frothed polyurethane composition of claim 8, wherein the plasticizer is dipropylene glycol dibenzoate.

10. A method for forming a frothed polyurethane composition exhibiting greater resiliency, energy absorption and force dissipation with materials of similar thicknesses, and of a substantially lighter weight and greater dimensional return elasticity comprising the steps of:
a. blending in a high pressure mix head complimentary proportional percentage amounts of 35% to 65% by volume of a partial pre-polymer and 65% to 35% by volume of a propylene-oxide based polyether polyol;
b. directing high pressure relatively inert gas at controlled volumetric flow rates into the mix head with the complimentary proportional percentage amounts of the partial pre-polymer and propylene-oxide based polyether polyol;
c. dispersing the reactive mixture through a spray head creating a frothed polyurethane composition deposited onto a backing member or form at a predetermined thickness for curing,
whereby the resulting composition has a molecular weight in the range between 4000 and 6000, a Shore Hardness in the range between 20A and 30A, and at least a 25% reduction in weight due to the frothing effect of the high pressure relatively inert gas.

11. The method of claim 10, comprising the additional step of mixing a catalyst with the propylene-oxide based polyether polyol prior to blending the complimentary proportional percentage amounts in the mix head.

12. The method of claim 10, wherein the catalyst is selected from the group consisting of amine and metal catalysts.

13. The method of claim 10, wherein the partial pre-polymer is selected from the group consisting of 4-4′-diphenylmethane diisocyanate (MDI), toluene-diisocyanate (TDI), and isopropyl-diisocyanate (IPDI), H₁₂MDI.

14. The method of claim 10, wherein the propylene-oxide based polyether polyol is selected from the group consisting of polypropylene glycol and polyethylene glycol.
